(19) United States
(12) Patent Application Publication
(10) Pub. No.: US 2024/0206388 A1
(43) Pub. Date: Jun. 27, 2024

(54) JOINT BLADE FOR MOWING

(71) Applicant: TWOY TECH CO., LTD., Busan (KR)

(72) Inventor: Yun Cheol SHIN, Busan (KR)

(73) Assignee: TWOY TECH CO., LTD., Busan (KR)

(21) Appl. No.: 17/912,410

(22) PCT Filed: May 12, 2022
(86) PCT No.: PCT/KR2022/006786

§ 371 Date: Sep. 16, 2022

(30) Foreign Application Priority Data
May 11, 2022 (KR) 10-2022-0057867

(51) Int. Cl. A01D 34/73; A01D 34/82; A01D 34/90; A01D 101/00

(52) U.S. Cl. CPC A01D 34/733; A01D 34/82; A01D 34/90; A01D 2101/00

(57) ABSTRACT

A joint blade for mowing includes: a rotating plate connected to a rotating power shaft to rotate; a cover plate coupled to the top of the rotating plate to overlap and having an insertion hole formed at the center so that the power shaft is inserted into the insertion hole; and a plurality of rotary blades coupled at the edge of the cover plate at regular intervals to be rotatable. The cover plate includes: a plate spring provided on one side of the cover plate adjacent to the rotary blade; and a buffer unit integrally provided with the plate spring.

### CROSS-REFERENCE TO PRIOR APPLICATIONS

This application is a National Stage Patent Application of PCT International Patent Application No. PCT/KR2022/006786 (filed on May 12, 2022) under 35 U.S.C. § 371, which claims priority to Korean Patent Application No. 10-2022-0057867 (filed on May 11, 2022), which are all hereby incorporated by reference in their entirety.

### BACKGROUND

The present invention relates to a joint blade for mowing, and more particularly, to a joint blade for mowing in which a plurality of rotary blades are coupled to a rotating plate, which rotates to perform mowing work, at equal intervals.

In general, in order to cultivate and use a place where there are lots of grains, weeds, scrubs, and the likes, a user has to remove weeds from the soil or picks out stones by turning the soil. A representative thing among farming instruments used for weed removal or picking out stones is a short half-moon hoe (called ‘homi’ in Korean).

However, the homi is avoided due to physical fatigue and inefficient capacity for work. Recently, a mowing machine, which uses a motor as a main power source to transmit driving power to a power transmission shaft, and, to which a rotating plate having a blade formed at an end of the power transmission shaft, has been developed so that the mowing machine can perform mowing work by cutting weeds or scrubs using rotary power of the blade while the blade of the mowing machine instead of a tool such as a sickle or a shovel approaches the weeds or the scrubs.

However, in the case of performing the mowing work as described above, since stones or other hard substances embedded in the ground are also removed together with weeds or scrubs, the blade of the mowing machine rubs the stones or the floor of the ground, and so, there is possibility that the blade is easily broken.

Moreover, since mowing work is performed for a long time, a worker's fatigue increases due to the weight of the mowing machine.

For instance, a conventional art 1 relates to a mowing machine having an embedded rotational blade. The mowing machine according to the conventional art includes a blade spreading by rotation of a rotating plate to remove weeds or scrubs, thereby preventing accidents due to breakage of a cutting device caused by stones bounced up during removal of weeds or scrubs.

The mowing machine having the rotational blade according to the conventional art can prevent accidents that the blade is broken or the worker gets hurt, but has a disadvantage in that the worker's fatigue may increase since the blade may be easily broken due to its shape and a floating force is not generated.

### PATENT DOCUMENTS

Patent Document 1: Korean Patent Laid-open No. 10-2015-0107489

### SUMMARY

Accordingly, the present invention has been made in view of the above-mentioned problems occurring in the related art, and it is an object of the present invention to provide a joint blade for mowing which generates a floating force from a cover plate to enhance a worker's efficiency, and in which a buffer unit integrated with a plate spring supports rotary blades coupled to the cover plate to rotate, thereby reducing vibration and noise.

The aspects of the present disclosure are not limited to those mentioned above, and other aspects not mentioned herein will be clearly understood by those skilled in the art from the following description.

To accomplish the above-mentioned objects, according to the present invention, there is provided a joint blade for mowing including: a rotating plate connected to a rotating power shaft to rotate; a cover plate coupled to the top of the rotating plate to overlap and having an insertion hole formed at the center so that the power shaft is inserted into the insertion hole; and a plurality of rotary blades coupled at the edge of the cover plate at regular intervals to be rotatable, wherein the cover plate includes: a plate spring provided on one side of the cover plate adjacent to the rotary blade; and a buffer unit integrally provided with the plate spring, and wherein while the rotating plate rotates, when the rotary blades, which are spread in the outward direction of the cover plate by the centrifugal force, collide against the foreign substance of the ground and are folded inwardly, the buffer units can alleviate impact generated when the rotary blades collide against the plate spring.

Moreover, the buffer unit is formed to be thicker than the cover plate to closely support the rotating plate and the cover plate at both sides, thereby minimizing vibration during rotation of the cover plate.

Furthermore, the cover plate includes a plurality of wing units formed on the side of the cover plate in a diagonal direction with respect to the circumference of the cover plate to induce a flow of air, thereby generating a floating force when the cover plate is rotated.

Additionally, the rotating plate includes: a plurality of rotating plate penetration holes formed on one side of the rotating plate; protrusions respectively protruding from one side of the rotating plate penetration holes and having a diameter larger than that of the rotary plate penetration hole; and fastening bolts respectively coupled to the rotating plate penetration holes, wherein the cover plate includes: a cover plate penetration hole formed at the same position as the penetration direction of the rotating plate penetration hole in a state of overlapping the rotating plate, wherein the rotary blade includes: a rotary blade penetration hole formed at an end of the rotary blade and having the same diameter s the inner circumferential surface of the protrusion; and a rotary support coupled to the rotary blade penetration hole so that the rotary blade serves as a rotatable shaft, and wherein when the fastening bolts sequentially pass through the rotating plate penetration hole and the rotary support and are coupled to the cover plate penetration holes in a state in which the washer is inserted, the rotary support is located on the protrusion.

In addition, the rotating plate includes: a plurality of rotating plate penetration holes formed on one side of the rotating plate; and fastening bolts respectively coupled to the rotating plate penetration holes, wherein the cover plate includes: a cover plate penetration hole formed at the same position as the penetration direction of the rotating plate penetration hole in a state of overlapping the rotating plate, wherein the rotary blade includes: a rotary blade penetration hole formed at an end of the rotary blade and having the same diameter as the inner circumferential surface of the protrusion; a rotary support coupled to the rotary blade penetration hole so that the rotary blade serves as a rotatable shaft; and a fixed protrusion protruding from an end in the longitudinal direction to have the same diameter as the rotating plate penetration hole, and wherein when the fastening bolts sequentially pass through the rotating plate penetration hole and the rotary support and are coupled to the cover plate penetration holes in a state in which the washer is inserted, the fixed protrusion is inserted into the rotating plate penetration hole.

Furthermore, the rotating plate includes: a plurality of rotating plate penetration holes formed on one side of the rotating plate; fastening bolts respectively coupled to the rotating plate penetration holes; and a washer disposed between the rotating plate and the fastening bolt, wherein the washer includes: a washer frame forming a main body of the washer; a washer wing part disposed at one side of the washer frame to be inclined; a washer through hole formed at one side of the washer frame; and a washer buffer part protruding from one side of the washer through hole, wherein when the washer buffer part is pressed in the state in which the fastening bolt is inserted into the washer through hole, the washer wing part gets in contact with the one side of the fastening bolt, thereby preventing the fastening bolt from being released from the washer through hole.

As described above, the joint blade for mowing according to the present invention generates a floating force by the wing unit of the rotating plate and the rotary blades to reduce the weight of the mowing machine during a worker performs mowing work, thereby enhancing work efficiency.

Moreover, the joint blade for mowing according to the present invention can reduce vibration and noise during rotation of the rotating plate since the rotary blades closely support the buffer unit formed integrally with the plate spring.

Furthermore, the joint blade for mowing according to the present invention can minimize a damage or a breakage of the rotary blades since the rotary blades have the plurality of grooves.

Additionally, the joint blade for mowing according to the present invention can prevent accidents since the rotary blades are not separated due to the assembly structure of the fastening bolt.

In addition, the joint blade for mowing according to the present invention can fasten the fastening bolt without release due to the washer applied to the joint blade for mowing.

The advantages of the present disclosure are not limited to the above-mentioned advantages, and other advantages, which are not specifically mentioned herein, will be clearly understood by those skilled in the art from the following description.

### BRIEF DESCRIPTION OF THE DRAWINGS

FIG. 1 is a top perspective view of a joint blade for mowing according to a first embodiment of the present invention.

FIG. 2 is a bottom perspective view of the joint blade for mowing according to the first embodiment of the present invention.

FIG. 3 is a side view of the joint blade for mowing according to the first embodiment of the present invention.

FIG. 4 is a plan view illustrating an inner appearance of a cover plate of the joint blade for mowing according to the first embodiment of the present invention.

FIG. 5 is a plan view illustrating a state in which rotary blades according to the first embodiment of the present invention are rotated by centrifugal force.

FIG. 6 is a perspective view illustrating a connection unit between the rotary blades and the cover plate of the joint blade for mowing according to the first embodiment of the present invention.

FIG. 7 is a plane view of FIG. 6, showing a plate spring and a buffer unit in detail.

FIG. 8 is a view illustrating a coupling structure of a fastening bolt of the joint blade for mowing according to the first embodiment of the present invention.

FIG. 9 is a view illustrating a coupling structure of a fastening bolt of the joint blade for mowing according to a second embodiment of the present invention.

FIG. 10 is a perspective view illustrating a washer of a joint blade for mowing according to a third embodiment of the present invention.

FIG. 11 is a view illustrating a state in which a fastening bolt and the washer of the joint blade for mowing according to the third embodiment of the present invention are coupled to each other.

FIG. 12 is a view illustrating a coupling structure of a fastening bolt of the joint blade for mowing according to the third embodiment of the present invention.

FIG. 13 is a bottom perspective view of the joint blade for mowing according to the third embodiment of the present invention.

FIG. 14 is a perspective view illustrating a state in which a joint blade for mowing according to a preferred embodiment of the present invention is coupled to a power shaft.

FIG. 15 is a view illustrating a guide plate of the joint blade for mowing according to the preferred embodiment of the present invention.

### DETAILED DESCRIPTION

The meaning of the terms used in the present disclosure will be briefly described with reference to the description, and the present invention will be described in detail.

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Thus, the terms used herein have to be defined based on the meaning of the terms together with the description throughout the specification.

Throughout this specification, when a certain unit “includes” a certain component, other components are not excluded unless explicitly described otherwise, and other components may in fact be included.

Hereinafter, the embodiments of the present disclosure will be described in detail with reference to accompanying drawings so that the embodiments may be easily implemented by those skilled in the art. However, the present disclosure may be implemented in various ways without being limited to the embodiments.

Specific matters including technical problems to be solved, technical solutions of the problems, and effects of the present invention are included in preferred embodiments and drawings of the present invention. Advantages and features of the present invention and methods of achieving the advantages and features will be described with reference to exemplary embodiments described in detail below together with the accompanying drawings.

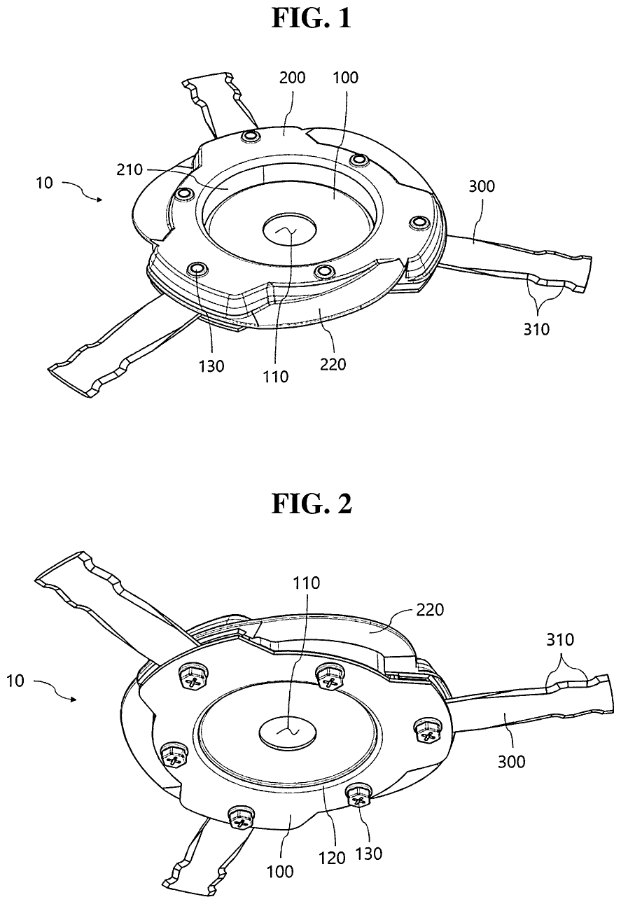

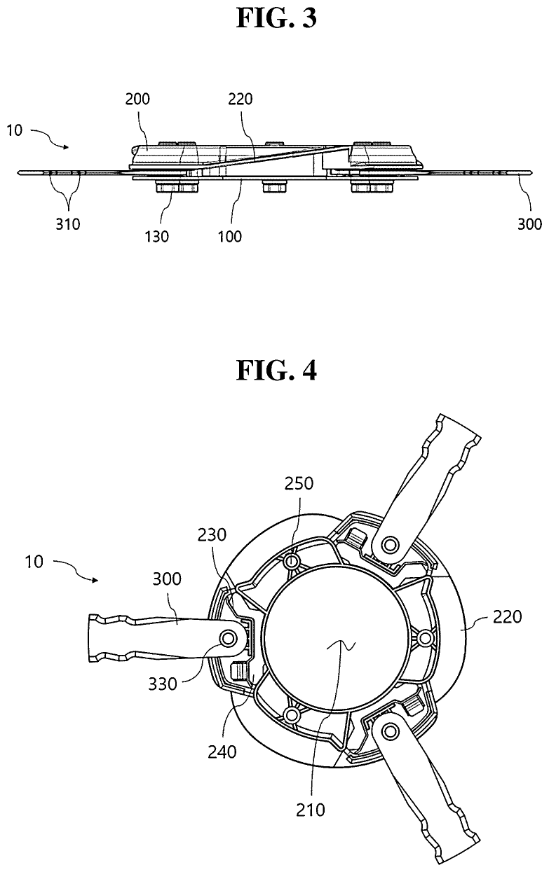

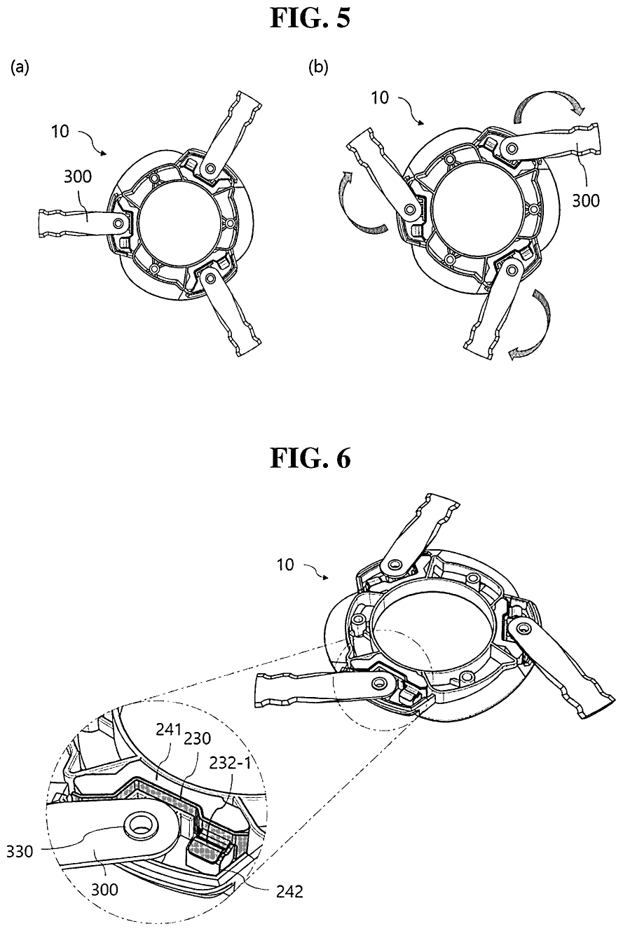

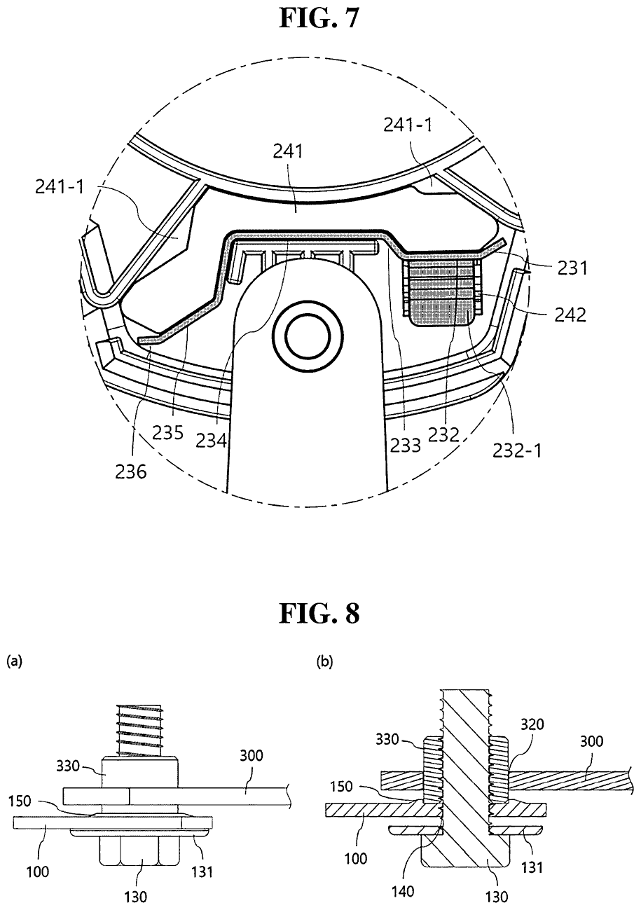

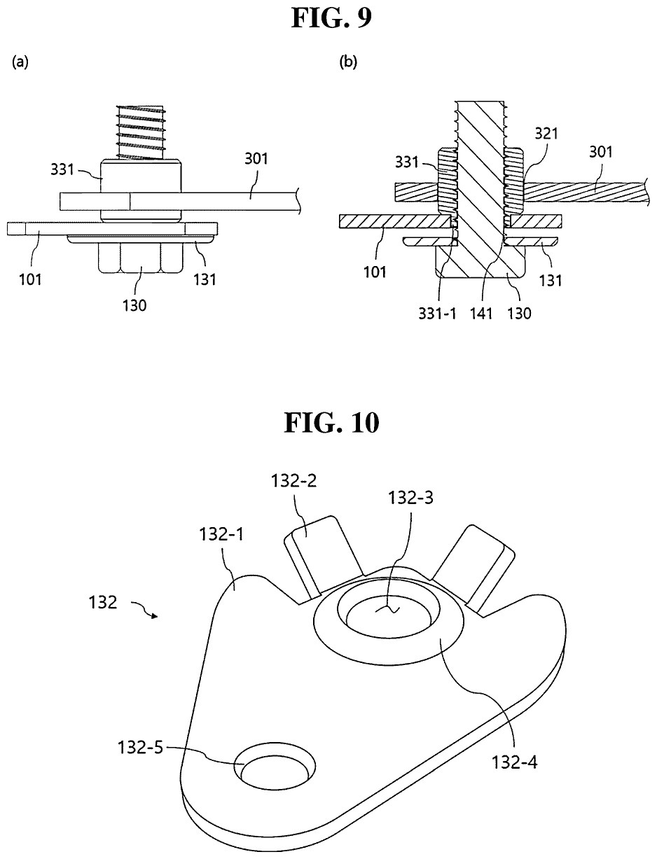

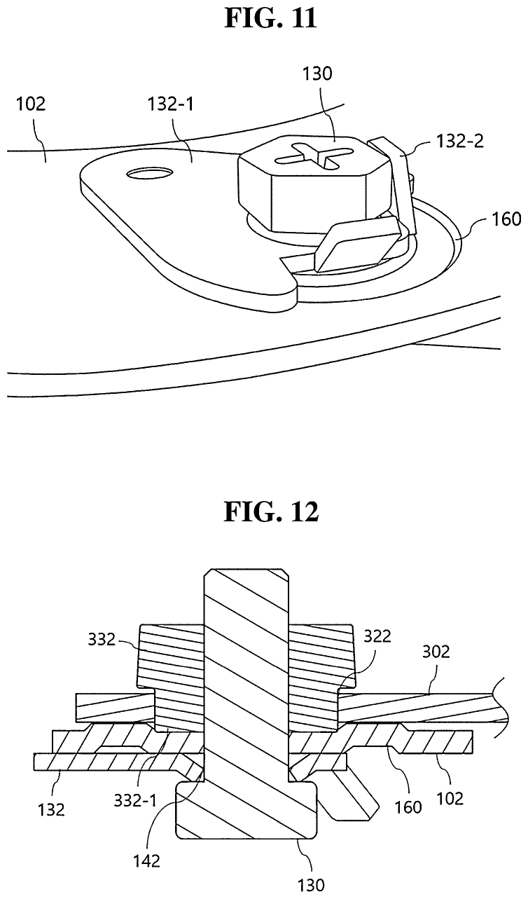

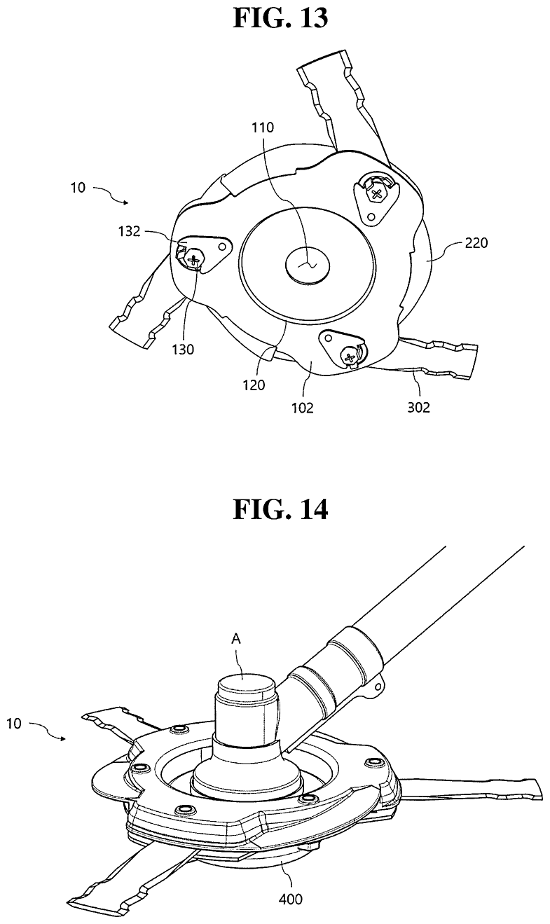

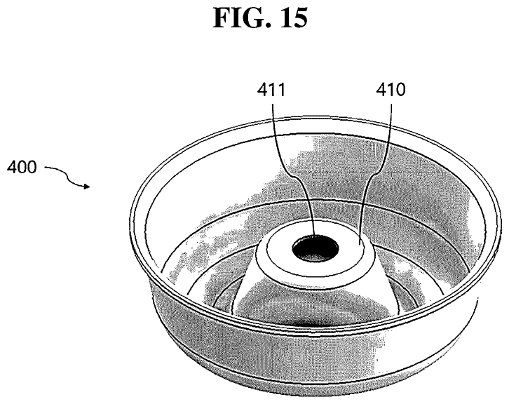

FIG. 1 is a top perspective view of a joint blade for mowing according to a first embodiment of the present invention, FIG. 2 is a bottom perspective view of the joint blade for mowing according to the first embodiment of the present invention, FIG. 3 is a side view of the joint blade for mowing according to the first embodiment of the present invention, FIG. 4 is a plan view illustrating an inner appearance of a cover plate of the joint blade for mowing according to the first embodiment of the present invention, FIG. 5 is a plan view illustrating a state in which rotary blades according to the first embodiment of the present invention are rotated by centrifugal force, FIG. 6 is a perspective view illustrating a connection unit between the rotary blades and the cover plate of the joint blade for mowing according to the first embodiment of the present invention, FIG. 7 is a plane view of FIG. 6, showing a plate spring and a buffer unit in detail, FIG. 8 is a view illustrating a coupling structure of a fastening bolt of the joint blade for mowing according to the first embodiment of the present invention, FIG. 9 is a view illustrating a coupling structure of a fastening bolt of the joint blade for mowing according to a second embodiment of the present invention, FIG. 10 is a perspective view illustrating a washer of a joint blade for mowing according to a third embodiment of the present invention, FIG. 11 is a view illustrating a state in which a fastening bolt and the washer of the joint blade for mowing according to the third embodiment of the present invention are coupled to each other, FIG. 12 is a view illustrating a coupling structure of a fastening bolt of the joint blade for mowing according to the third embodiment of the present invention, FIG. 13 is a bottom perspective view of the joint blade for mowing according to the third embodiment of the present invention, FIG. 14 is a perspective view illustrating a state in which a joint blade for mowing according to a preferred embodiment of the present invention is coupled to a power shaft, and FIG. 15 is a view illustrating a guide plate of the joint blade for mowing according to the preferred embodiment of the present invention.

A joint blade for mowing 10 according to a preferred embodiment of the present invention generates a floating force so as to enhance a worker's efficiency and reduce vibration and noise.

Hereinafter, the joint blade for mowing according to a first embodiment of the present invention will be described in detail with reference to the accompanying drawings.

The joint blade for mowing 10 according to the first embodiment of the present invention includes: a rotating plate 100 connected to a power shaft A, which is connected to a power shaft (not shown) to rotate, to rotate; a cover plate 200 coupled to the top of the rotating plate 100 to overlap and having an insertion hole 210 formed at the center so that the power shaft A is inserted into the insertion hole; and a plurality of rotary blades 300 coupled at the edge of the cover plate 200 at regular intervals to be rotatable.

First, referring to FIGS. 1 to 3, the rotating plate 100 is provided. The rotating plate 100 is formed in a circular plate shape, and is cut inwardly at portions to which the rotary blades 300 are coupled. That is, the rotating plate 100 is generally formed in a triangular plate shape. The rotating plate 100 includes a power connection hole 110 formed at the center thereof. The power shaft A is inserted into the power connection hole 210. The rotating plate 100 further includes a mounting groove 120 formed in the opposite direction to the power shaft A inserted thereinto. The mounting groove 120 has a circular shape and is formed to be larger in diameter than the power connection hole 110. A guide plate 400 which will be described later is mounted on the mounting groove 120, and other various accessories may be mounted on the mounting groove 120.

Next, the cover plate 200 is provided. The cover plate 200 is configured to perform mowing work to remove weeds while rotating. be rotated while rotating to remove weeds. An insertion hole 210 is formed in a central portion of the cover plate 200. The power shaft A is also inserted into the insertion hole 210 like the power connection hole 110. The cover plate 200 is coupled to the rotating plate 100 by fastening bolts 130 to overlap the rotating plate 100. Therefore, when the power shaft A rotates, the rotating plate 100 and the cover plate 200 rotate together with the power shaft A.

In addition, the cover plate 200 includes a plurality of wing units 220 formed on the side of the cover plate 200 in a diagonal direction with respect to the circumference of the cover plate 200 to induce a flow of air. More specifically, the wing units 220 are formed on the side of the cover plate 200 corresponding an area between the rotary blades 300 and are formed in a diagonal direction to be inclined upward. That is, when the cover plate 200 is rotated by the principle of a propeller, the wing units 220 can induce the flow of air to make an ascending air current. In addition, the wing units 220 are formed to have an upward slope or a downward slope according to the rotational direction of the cover plate 200. In addition, the wing units 220 may have various widths. That is, the wing units 220 may be formed in such a way that the width is gradually increased or decreased. As a result, the cover plate 200 generates a floating force by the wind units 220, thereby enhancing a worker's efficiency during mowing work.

Next, the rotary blades 300 are provided. The rotary blades 300 are coupled to the side of the cover plate 300 corresponding to the edge of the cover plate 300 at regular intervals. Furthermore, the rotary blades 300 are rotatably coupled. Accordingly, when the cover plate 300 rotates, the rotary blades 300 are spread out in the vertical direction of the cover plate 300 by centrifugal force. In addition, each of the rotary blades 300 is formed in a straight form as a whole. Each of the rotary blades 300 includes blade grooves 310 formed in both longitudinal sides of the rotary blade 300. That is, a plurality of the blade grooves 310 formed in a ‘V’ shape are formed. Furthermore, the blade grooves 310 are formed in length of 50 mm on both end surfaces of the rotary blade 300 in the longitudinal direction of the rotary blade 300, and is inclined at an angle of 15° with respect to the center of the rotary blade 300. Of course, the interval and depth of the blade grooves 310 may be varied according to the object to be cut. That is, the object to be cut is cut along the inclined surface by the blade grooves 310. As a result, the cutting force of the rotary blades 300 is improved due to the blade grooves 310 formed on the rotary blades 300.

In addition, referring to FIG. 4, the cover plate 200 includes a plate spring 230 provided on one side of the cover plate 200 adjacent to the rotary blade 300 and a buffer unit 240 integrally provided with the plate spring 230. The plate spring 230 is provided inside the cover plate 200 corresponding to the rear surface of the rotary blade 300. The plate spring 230 is made of a metal material and is continuously bent. The buffer unit 240 is provided to support the rear surface of the plate spring 230 according to the bent shape of the plate spring 230. In addition, the buffer unit 240 is made of a rubber material having elasticity to alleviate an impact. In addition, the buffer unit 240 is formed to be thicker than the cover plate 200 to closely support the rotating plate 100 and the cover plate 200 at both sides, thereby minimizing vibration during rotation of the cover plate 200.

Moreover, the cover plate 200 includes a cover plate penetration hole 250 formed at the same position as the penetration direction of the rotating plate penetration hole 140 in a state of overlapping the rotating plate 100. The fastening bolt 130 coupled to the rotating plate 100 is coupled to the cover plate penetration hole 250.

Referring to FIG. 5(A), the rotary blades 300 are spread out in the outward direction of the cover plate 200 by centrifugal force according to the rotation of the cover plate 200. Thereafter, referring to FIG. 5(B), when the rotary blades 300 collide against a foreign substance of the ground while the worker performs the mowing work, the rotary blades 300 rotate in the inward direction of the cover plate 200. In this instance, one surface of the rotary blade 300 comes into contact with the plate spring 230 provided inside the cover plate 200.

In sum, while the rotating plate 100 rotates, when the rotary blades 300, which are spread in the outward direction of the cover plate 200 by the centrifugal force, collide against the foreign substance of the ground and are folded inwardly, the buffer units 240 can alleviate impact generated when the rotary blades 300 against with the plate spring 200.

Additionally, referring to FIGS. 6 to 7, the plate spring 230 includes a first inclined surface 231, a first bottom surface 232, a second inclined surface 233, a second bottom surface 234, a third inclined surface 235, and a fourth inclined surface 236.

The first inclined surface 231 is an end of the plate spring 230, and is formed to be inclined upward in a direction in which the rotary blades 300 are positioned to be assembled inside the cover plate 200.

The first bottom surface 232 is a portion extending from the first inclined surface 231 and is formed perpendicular to the spreading direction of the rotary blades 300. The first bottom surface 232 has a plate spring protrusion 232-1. The plate spring protrusion 232-1 protrudes from the first bottom surface 232 in the spreading direction of the rotary blades 300, and holds and fixes both surfaces of a second buffer part 242, which will be described later.

The second inclined surface 233 is a portion extending from the first bottom surface 232, and is inclined downward in the inner direction of the cover plate 200.

The second bottom surface 234 is a portion extending from the second inclined surface 233, and is formed perpendicular to the first bottom surface 232. The second bottom surface 234 is formed to be wider than the rotary blade 300.

The third inclined surface 235 is a portion extending from the second bottom surface 234, and is formed to be inclined upward in a direction in which the rotary blade 300 is located. The third inclined surface 235 gets in contact with one surface of the rotary blade 350. In this instance, the rotary blade 300 are in contact with a portion in which the blade is not formed.

The fourth inclined surface 236 is the other end of the plate spring 230, and is formed to be inclined downward in the inward direction of the cover plate 200 so as to be assembled inside the cover plate 200 like the first inclined surface 231.

Therefore, the plate spring 230 includes the first inclined surface 231, the first bottom surface 232, the second inclined surface 233, the second bottom surface 234, the third inclined surface 235, and the fourth inclined surface 236 to form a continuously curved shape, thereby absorbing the impact of the rotary blade 300 which collides against the third inclined surface 235. Of course, the first inclined surface 231, the first bottom surface 232, the second inclined surface 233, the second bottom surface 234, the third inclined surface 235, and the fourth inclined surface 236 may be varied in their length and inclination angle according to the internal structure of the cover plate 200 and the shape of the rotary blade 300.

Additionally, the buffer unit 240 includes a first buffer part 241, a buffer groove 241-1, and a second buffer part 242.

The first buffer part 241 is disposed on the rear surface of the plate spring 230, and has one surface having the same curved shape as the plate spring 230 and the other surface having the same shape as the outer circumferential surface of the insertion hole 210. That is, the first buffer part 241 supports the plate spring 230 on one surface and supports the inner surface of the cover plate 200 on the other surface.

The first buffer part 241 has the buffer groove 241-1. The buffer groove 241-1 forms an empty space between the first buffer part 241 and the inner frame of the cover plate 300. The buffer groove 241-1 is formed in a V-shape and may be formed in plural. That is, the first buffer part 241 secures a space that the impact of the rotary blades 300 is pushed in the inward direction of the cover plate 200 to further absorb the impact.

The second buffer part 242 is provided on the plate spring protrusion 232-1 and is fixed to the cover plate 200 at one side. Accordingly, the second buffer part 242 serves to fix the movement of the plate spring 230.

In addition, referring to FIGS. 8(A) and 8(B), the rotating plate 100 includes a plurality of rotating plate penetration holes 140 formed on one side of the rotating plate 100, protrusions 150 respectively protruding from one side of the rotating plate penetration holes 140 and having a diameter larger than that of the rotary plate penetration hole 140, and fastening bolts 130 respectively coupled to the rotating plate penetration holes 140.

The protrusion 150 protrudes to have a diameter larger than that of the rotating plate penetration hole 140 with respect to the center of the rotating plate penetration hole 140. In addition, the protrusion 150 is formed such that the height thereof gradually decreases as gradually being far away from the rotating plate penetration hole 140. In other words, the protrusion 150 is formed to be inclined downward in the outward direction of the rotating plate penetration hole 140.

The fastening bolt 130 has a length capable of being coupled from the rotating plate penetration hole 140 to the cover plate penetration hole 250 in the state in which the rotating plate 100 and the cover plate 200 overlap each other. The fastening bolt 130 includes a bolt main body having a screw thread and a head provided to rotate the bolt main body.

In addition, the rotary blade 300 includes a rotary blade penetration hole 320 formed at an end of the rotary blade 300 and having the same diameter as the inner circumferential surface of the protrusion 150, and a rotary support 330 coupled to the rotary blade penetration hole 320 so that the rotary blade serves as a rotatable shaft.

When the fastening bolts 130 sequentially pass through the rotating plate penetration hole 140 and the rotary support 330 and are coupled to the cover plate penetration holes 250 in a state in which the washer 131 is inserted, the rotary support 330 is located on the protrusion 150.

Accordingly, since the rotary support 330 is inserted into the protrusion 150, the rotary support 330 is fixed to prevent the rotary blades 300 from being separated.

Hereinafter, a joint blade for mowing 10 according to a second embodiment of the present invention will be described in detail with reference to the accompanying drawings.

The second embodiment is different from the first embodiment in the coupling structure of the fastening bolts 130. Since the configuration of t joint blade for mowing 10 according to the second embodiment except the configurations of a rotating plate 101 and rotary blades 301 is the same as the first embodiment, description of the second embodiment quotes the description of the first embodiment.

Referring to FIGS. 9(A) and 9(B), the articulated blade 10 according to the second embodiment includes the rotating plate 101 and the rotary blades 301.

The rotating plate 101 includes a plurality of rotating plate penetration holes 141 formed on one side of the rotating plate 101. Each of the rotary blade 301 includes a rotary blade penetration hole 321 formed at one end of the rotary blade 301 and having a diameter larger than that of the rotary plate penetration hole 141, and a rotary support 331 coupled to the rotary blade penetration hole 321 so that the rotary blade 301 serves as a rotatable shaft.

In addition, the rotary support 331 has a fixed protrusion 331-1 protruding from an end in the longitudinal direction to have the same diameter as the rotating plate penetration hole 141. Preferably, the height of the fixed protrusion 331-1 is equal to the thickness of the rotating plate 101.

Furthermore, in the state in which the washer 131 is inserted, when the fastening bolt 130 sequentially passes through the rotary plate penetration hole 141 and the rotary support 331 to be coupled to the cover plate penetration hole 250, the fixed protrusion 331-1 is inserted into the rotary plate penetration hole 141.

Therefore, since the fixed protrusion 331-1 is inserted into the rotating plate penetration hole 141, the rotary support 331 is fixed, thereby preventing the rotary blade 301 from being separated.

Hereinafter, a joint blade for mowing 10 according to a third embodiment of the present invention will be described in detail with reference to the accompanying drawings.

The third embodiment is different from the first embodiment in the coupling structure of the fastening bolts 130. Since the configuration of the joint blade for mowing 10 according to the second embodiment except the configurations of a rotating plate 102 and rotary blades 302 is the same as the first embodiment, description of the second embodiment quotes the description of the first embodiment.

Referring to FIGS. 10 to 13, the joint blade for mowing 10 according to the third embodiment of the present invention includes the rotating plate 102 and the rotary blades 302.

The rotating plate 102 includes a plurality of rotating plate penetration holes 142 formed on one side of the rotating plate 102, fastening bolts 130 respectively coupled to the rotating plate penetration holes 142, washers 132 respectively provided between the rotating plates 102 and the fastening bolts 130, and support fixing units 160 respectively formed outside the rotating plate penetration holes 142.

Additionally, referring to FIG. 10, the washer 142 includes a washer frame 132-1, a washer wing part 132-2, a washer through hole 132-3, a washer buffer part 132-4, and a washer groove 132-5.

The washer frame 132-1 is a main body of the washer 142 and is formed in a plate shape. An end of the washer frame 132-1 is formed in a ‘W’-shape, and the other end of the washer frame 132-1 is formed to have a curvature.

The washer wing part 132-2 is inclined from one side of the washer frame 132-1. More specifically, the washer wing part 132-2 is formed in a rectangular shape and a plurality of the washer wing parts are provided. The plurality of washer wing parts 132-2 are provided to be symmetrical to each other with respect to a longitudinal central portion of the washer frame 132-1. In addition, the plurality of washer wings 132-2 are preferably provided to face the center of the washer frame 132-1.

The washer through hole 132-3 is formed at one side of the washer frame 132-1. More specifically, the washer through hole 132-3 is formed at a position adjacent to the washer wing part 132-2 at the longitudinally central portion of the washer frame 132-1. In addition, preferably, the washer through hole 132-3 is formed at a point where the centers of the washer wing parts 132-2 meet each other in the washer frame 132-1.

The washer buffer part 132-4 protrudes from one side of the washer through hole 132-3. More specifically, the washer buffer part 132-4 protrudes to have a diameter larger than that of the washer through hole 132-3 with respect to the center of the washer through hole 132-3. In addition, the washer buffer part 132-4 is formed such that the height thereof gradually decreases as the washer through hole 132-3 gets gradually away from the washer through hole 132-3. In other words, the washer buffer part 132-4 is formed to be inclined downward in the outward direction of the washer through hole 132-3.

The washer groove 132-5 is formed on one side of the washer frame 132-1. More specifically, the washer groove 132-5 is formed at a position spaced apart from the washer through hole 132-3 at the longitudinally central portion of the washer frame 132-1. Preferably, the washer groove 132-5 is formed at a position adjacent to the other end of the washer frame 132-1.

The washer 142 can prevent loosening of the fastening bolt 130. More specifically, in a case in which the fastening bolt 130 is inserted into the washer through hole 132-3, the washer buffer part 132-4 is pressed against the head of the fastening bolt 130, thereby preventing the washer buffer part 132-4 from being released by vibration. In addition, referring to FIG. 11, while the fastening bolt 130 is inserted and presses the washer buffer part 132-4, the washer wing part 132-2 can be fixed since the inclination angle is increased and the washer wing part gets in contact with one side of the head of the fastening bolt 130. That is, when the washer buffer part 132-4 is pressed in the state in which the fastening bolt 130 is inserted into the washer through hole 132-3, the washer wing part 132-2 gets in contact with the one side of the fastening bolt 130, thereby preventing the fastening bolt 130 from being released from the washer through hole 132-3.

The support fixing unit 160 is bent to have a diameter larger than that of the rotating plate penetration hole 142 with respect to the center of the rotating plate penetration hole 142. More specifically, the support fixing unit 160 is bent in a direction in which the rotary blade 302 is located on the rotating plate 102 when the rotating plate 102 is viewed from the top. Accordingly, the support fixing unit 160 may support the rotary blade 302.

In addition, referring to FIG. 12, the rotary blade 302 includes a rotary blade penetration hole 322 formed at one end of the rotary blade 302, and a rotary support 332 coupled to the rotary blade penetration hole 322 so that the rotary blade 302 serves as a rotatable shaft.

The rotary blade penetration hole 322 is formed to have a diameter larger than that of the rotary plate penetration hole 142, and has the same diameter as the point where the bending starts between the plurality of support fixing parts 160.

Additionally, the rotary support 332 includes a fixed protrusion 332-1 protruding from a longitudinal end of the rotary support 332 to have the same diameter as the rotary blade penetration hole 322. Preferably, the height of the fixed protrusion 332-1 is greater than the thickness of the rotating plate 102.

Moreover, in the state in which the washer 132 is inserted, when the fastening bolt 130 sequentially passes through the rotary plate penetration hole 142 and the rotary support 332 and is coupled to the cover plate penetration hole 250, the rotary support 332 is positioned between the support fixing parts 160.

Accordingly, the fixed protrusion 332-1 is disposed between the plurality of support fixing parts 160, and as a result, the rotary support 332 is fixed to prevent the rotary blade 302 from being separated.

Referring to FIG. 13, the washer 132 is preferably provided in a range which does not deviate from the outer diameter of the rotating plate 102. More specifically, the washer frame 132-1 is in close contact with the rotating plate 102 by the fastening bolt 130, and is provided not to deviate from the outer diameter of the rotating plate 102.

Referring to FIG. 14, the joint blade for mowing 10 having the above-described configuration is connected to the power shaft A so that a worker can perform mowing work. Specifically, the power shaft A is in the form of a rod that the worker can grasp with the hand during mowing work, and has a predetermined length. In addition, the power shaft A has a power source disposed at one side to supply rotational power, and a shaft (not shown) formed at the other side to transmit the rotational power. In this instance, the power source may be a motor, and a detailed description thereof will be omitted since the power source is widely known in the art by a person skilled in the art.

Referring to FIGS. 14 to 15, the joint blade for mowing 10 further includes a guide plate 400 mounted on a lower portion of the rotating plate 100. More specifically, the guide plate 400 is provided in the form of a hollow container. Furthermore, the guide plate 400 includes a guide plate protrusion 410 protruding from a central portion thereof. The guide plate protrusion 410 includes a guide through hole 411 formed in a central portion of the guide plate protrusion 410. That is, the guide plate protrusion 410 meets the surface of the rotating plate 100 in which the power connection hole 110 is formed, and the guide penetration hole 411 is connected to the power connection hole 110. As a result, the guide plate 400 serves as a flat sliding plate while the worker performs mowing work.

The above description is only exemplary, and it will be understood by those skilled in the art that the invention may be embodied in other forms concrete without changing the technological scope and essential features.

Therefore, the above-described embodiments should be considered only as examples in all aspects and not for purposes of limitation. The scope of the present invention is defined by the appended claims, and encompasses all modifications or alterations derived from meanings, the scope and equivalents of the appended claims.

### EXPLANATION OF REFERENCE NUMERALS

A: power shaft
10: joint blade for mowing
100: rotating plate
101: rotating plate
102: rotating plate
110: power connection hole
120: mounting groove
130: fastening bolt
131: washer
132: washer
132-1: washer frame
132-2: washer wing part
132-3: washer through hole
132-4: washer buffer part
132-5: washer groove
140: rotating plate penetration hole
141: rotating plate penetration hole
142: rotating plate penetration hole
150: protrusion
160: support fixing unit
200: cover plate
210: insertion hole
220: wing unit
230: plate spring
231: first inclined surface
232: first bottom surface
232-1: plate spring protrusion
233: second inclined surface
234: second bottom surface
235: third inclined surface
236: fourth inclined surface
240: buffer unit
241: first buffer part
241-1: buffer groove
242: second buffer part
250: cover plate penetration hole
300: rotary blade
301: rotary blade
302: rotary blade
310: blade groove
320: rotary blade penetration hole
321: rotary blade penetration hole
322: rotary blade penetration hole
330: rotary support
331: rotary support
331-1: fixed protrusion
332: rotary support
332-1: fixed protrusion
400: guide plate
410: guide plate protrusion
411: guide through hole

1. A joint blade for mowing comprising:
a rotating plate connected to a rotating power shaft to rotate;
a cover plate coupled to the top of the rotating plate to overlap and having an insertion hole formed at the center so that the power shaft is inserted into the insertion hole; and
a plurality of rotary blades coupled at the edge of the cover plate at regular intervals to be rotatable,
wherein the cover plate includes:
a plate spring provided on one side of the cover plate adjacent to the rotary blade; and
a buffer unit integrally provided with the plate spring, and
wherein while the rotating plate rotates, when the rotary blades, which are spread in the outward direction of the cover plate by the centrifugal force, collide against the foreign substance of the ground and are folded inwardly, the buffer units alleviates impact generated when the rotary blades collide against the plate spring.

2. The joint blade for mowing according to claim 1, wherein the buffer unit is formed to be thicker than the cover plate to closely support the rotating plate and the cover plate at both sides, thereby minimizing vibration during rotation of the cover plate.

3. The joint blade for mowing according to claim 1, wherein the cover plate includes a plurality of wing units formed on the side of the cover plate in a diagonal direction with respect to the circumference of the cover plate to induce a flow of air, thereby generating a floating force when the cover plate is rotated.

4. The joint blade for mowing according to claim 1, wherein the rotating plate comprises:
a plurality of rotating plate penetration holes formed on one side of the rotating plate;
protrusions respectively protruding from one side of the rotating plate penetration holes and having a diameter larger than that of the rotary plate penetration hole; and
fastening bolts respectively coupled to the rotating plate penetration holes,
wherein the cover plate includes:
a cover plate penetration hole formed at the same position as the penetration direction of the rotating plate penetration hole in a state of overlapping the rotating plate,
wherein the rotary blade includes:
a rotary blade penetration hole formed at an end of the rotary blade and having the same diameter as the inner circumferential surface of the protrusion; and
a rotary support coupled to the rotary blade penetration hole so that the rotary blade serves as a rotatable shaft, and
wherein when the fastening bolts sequentially pass through the rotating plate penetration hole and the rotary support and are coupled to the cover plate penetration holes in a state in which the washer is inserted, the rotary support is located on the protrusion.

5. The joint blade for mowing according to claim 1, wherein the rotating plate comprises:
a plurality of rotating plate penetration holes formed on one side of the rotating plate; and
fastening bolts respectively coupled to the rotating plate penetration holes,
wherein the cover plate includes:
a cover plate penetration hole formed at the same position as the penetration direction of the rotating plate penetration hole in a state of overlapping the rotating plate,
wherein the rotary blade includes:
a rotary blade penetration hole formed at an end of the rotary blade and having the same diameter as the inner circumferential surface of the protrusion;
a rotary support coupled to the rotary blade penetration hole so that the rotary blade serves as a rotatable shaft; and
a fixed protrusion protruding from an end in the longitudinal direction to have the same diameter as the rotating plate penetration hole, and
wherein when the fastening bolts sequentially pass through the rotating plate penetration hole and the rotary support and are coupled to the cover plate penetration holes in a state in which the washer is inserted, the fixed protrusion is inserted into the rotating plate penetration hole.

6. The joint blade for mowing according to claim 1, wherein the rotating plate comprises:
a plurality of rotating plate penetration holes formed on one side of the rotating plate;
fastening bolts respectively coupled to the rotating plate penetration holes; and
a washer disposed between the rotating plate and the fastening bolt,
wherein the washer includes:
a washer frame forming a main body of the washer;
a washer wing part disposed at one side of the washer frame to be inclined;
a washer through hole formed at one side of the washer frame; and
a washer buffer part protruding from one side of the washer through hole,
wherein when the washer buffer part is pressed in the state in which the fastening bolt is inserted into the washer through hole, the washer wing part gets in contact with the one side of the fastening bolt, thereby preventing the fastening bolt from being released from the washer through hole.
